(19) United States
(12) Patent Application Publication
(10) Pub. No.: US 2026/0162641 A1
(43) Pub. Date: Jun. 11, 2026

(54) STRUCTURE FOR ACOUSTIC ATTENUATION OVER A WIDE RANGE OF FREQUENCIES

(71) Applicant: SAFRAN, Paris (FR)

(72) Inventors: Nicolas Pierre LANFANT, Moissy-Cramayel (FR); Jacky Novi MARDJONO, Moissy-Cramayel (FR); Hugues Laurent ALGLAVE, Moissy-Cramayel (FR); Marc VERSAEVEL, Moissy-Cramayel (FR); Patrick DUNLEAVY, Moissy-Cramayel (FR)

(73) Assignee: SAFRAN, Paris (FR)

(21) Appl. No.: 18/707,524

(22) PCT Filed: Oct. 27, 2022
(86) PCT No.: PCT/FR2022/052045

§ 371 Date: May 3, 2024

(30) Foreign Application Priority Data
Nov. 5, 2021 (FR) FR2111768

(51) Int. Cl. G10K 11/172; F02K 1/82

(52) U.S. Cl. CPC G10K 11/172; F02K 1/827; F05D 2260/963

(57) ABSTRACT

The invention relates to an acoustic attenuation structure comprising a lower multicellular structure and an upper multicellular structure, at least part of the cells of the upper multicellular structure opening out at least partially into one or several cells of the lower multicellular structure, the acoustic attenuation structure being characterized in that a hollow acoustic element having a shape gradually tapering between a base and a top is present in each cell of at least part of the lower multicellular structure.

### TECHNICAL FIELD

The present invention relates to the general field of acoustic attenuation structures. It more particularly concerns the acoustic attenuation structures used to reduce the noise produced in aircraft engines as well as in gas turbines or exhaust thereof.

### PRIOR ART

The acoustic attenuation structures are typically made up of an acoustic surface plate or skin permeable to the acoustic waves to be attenuated and of a solid reflective plate or skin called “closing plate”, a cellular body being disposed between these two walls. The cell body is generally made up of a set of partitions, for example in the shape of a honeycomb. In a well-known manner, such structures form Helmholtz-type resonators which make it possible to attenuate the acoustic waves in a certain frequency range.

Acoustic attenuation structures of this type are in particular described in documents U.S. Pat. No. 5,912,442 and GB 2 314 526. However, the acoustic attenuation structures previously described only make it possible to absorb a very restricted frequency range.

It is desirable to produce acoustic attenuation structures largely processing the low frequencies, while having satisfactory performance in the medium and high frequencies for example in the case of a fan of a slow-fan engine, which produces low frequencies and harmonics. Furthermore, the bulk and the mass of the acoustic attenuation structure must be preferably limited, for example when it is mounted on an aircraft.

To expand the range of absorbed frequencies, it is known to superimpose two cell bodies, preferably each having a honeycomb structure of different size to process different frequencies. However, this solution has limitations in the processing of the low frequencies. Indeed, in order to reduce the lowest frequencies, it is necessary to use very thick cell bodies. Thus, the acoustic attenuation structure comprising two cellular bodies stacked to process both low and high frequencies will be relatively bulky.

### DISCLOSURE OF THE INVENTION

The main aim of the present invention is therefore to propose an acoustic attenuation structure making it possible to process a wide frequency range, while maintaining reduced mass and bulk.

In accordance with the invention, this aim is achieved thanks to an acoustic attenuation structure comprising a lower multicellular structure and an upper multicellular structure, at least part of the cells of the upper multicellular structure opening out at least partially into one or several cells of the lower multicellular structure, the acoustic attenuation structure being characterized in that a hollow acoustic element having a shape gradually tapering between a base and a top is present in each cell of at least part of the lower multicellular structure.

Thus, the use of complex hollow acoustic elements in one of the multicellular acoustic structures makes it possible to process low frequencies with a limited bulk. The use of a second acoustic attenuation structure simultaneously allows processing higher frequencies.

According to one particular characteristic of the invention, the base of the hollow acoustic element is present at the end of the cell of the lower multicellular structure located facing the upper multicellular structure.

Thus, since the base of the complex hollow acoustic elements is not located at the end of the acoustic attenuation structure but at an intermediate height, the low, medium and high frequencies can be processed.

According to another particular characteristic of the invention, an intermediate acoustic skin is present at the end of the cells of the upper multicellular structure located facing the cells of the lower multicellular structure having hollow acoustic elements.

According to another particular characteristic of the invention, the intermediate acoustic skin is in contact with the base of the hollow acoustic elements present in the cells of the lower multicellular structure.

According to another particular characteristic of the invention, the acoustic attenuation structure further comprises an intermediate multicellular structure so that at least part of the cells of the intermediate multicellular structure opens out at least partially into one or several cells of the lower multicellular structure and at least partially in one or several cells of the upper multicellular structure.

According to another particular characteristic of the invention, each hollow acoustic element comprises extension walls extending from the base of said acoustic element to the intermediate acoustic skin.

According to another particular characteristic of the invention, the cells of the lower multicellular structure have a geometric shape identical to the geometric shape of the cells of the upper multicellular structure.

According to another particular characteristic of the invention, the cells of the lower multicellular structure have an area section different from the area of the section of the cells of the upper multicellular structure.

According to another particular characteristic of the invention, the height of the cells of the lower multicellular structure is different from the height of the cells of the upper multicellular structure.

According to another particular characteristic of the invention, the cells of the lower multicellular structure extend along a first direction and the cells of the upper multicellular structure extend along a second direction, the first direction and the second direction being secant.

### BRIEF DESCRIPTION OF THE DRAWINGS

FIG. 1 is a schematic exploded perspective view of an acoustic attenuation structure according to one embodiment of the invention.

FIG. 2 is a schematic sectional view of the acoustic attenuation structure of FIG. 1 once assembled.

FIG. 3 is a graphical representation of the acoustic attenuation coefficient as a function of the frequency of the acoustic attenuation structure of FIGS. 1 and 2 compared to the two other acoustic attenuation structures.

FIG. 4 is a schematic sectional view of the acoustic attenuation structure of FIG. 1 once assembled with a misalignment of the cells.

FIG. 5 is a schematic exploded perspective view of an acoustic attenuation structure according to one embodiment of the invention, in which the upper cells are narrower than the lower cells.

FIG. 6 is a schematic sectional view of the acoustic attenuation structure of FIG. 5 once assembled.

FIG. 7 is a schematic exploded perspective view of an acoustic attenuation structure according to one embodiment of the invention, in which the upper cells are inclined relative to the lower cells.

FIG. 8 is a schematic sectional view of the acoustic attenuation structure of FIG. 7 once assembled.

FIG. 9 is a schematic exploded perspective view of an acoustic attenuation structure according to one embodiment of the invention, in which an intermediate acoustic skin is inserted against the hollow acoustic elements.

FIG. 10 is a schematic sectional view of the acoustic attenuation structure of FIG. 9 once assembled.

FIG. 11 is a schematic exploded perspective view of an acoustic attenuation structure according to one embodiment of the invention, in which an intermediate acoustic skin is inserted between the upper multicellular structure and an intermediate multicellular structure.

FIG. 12 is a schematic sectional view of the acoustic attenuation structure of FIG. 11 once assembled.

FIG. 13 is a schematic exploded perspective view of an acoustic attenuation structure according to one embodiment of the invention, in which the acoustic component comprises extension walls.

FIG. 14 is a schematic sectional view of the acoustic attenuation structure of FIG. 13 once assembled.

### DESCRIPTION OF THE EMBODIMENTS

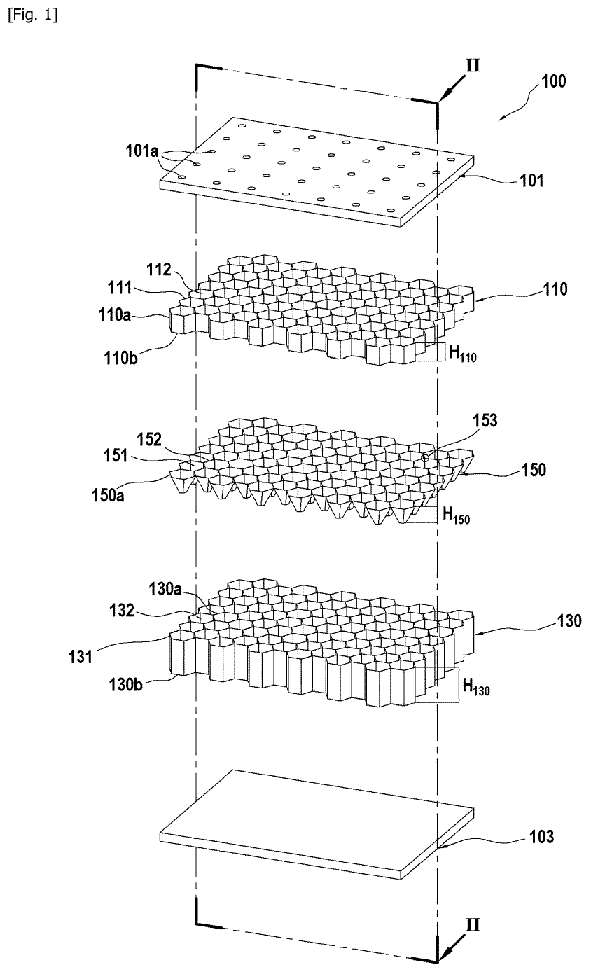

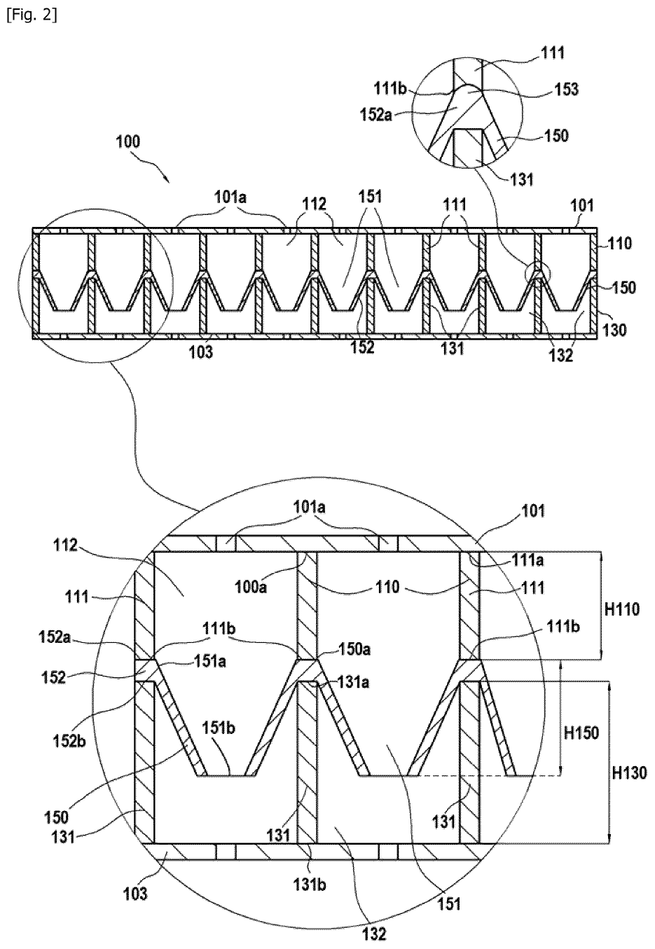

FIGS. 1 and 2 illustrate an acoustic attenuation structure 100 comprising in order an upper acoustic skin 101, an upper multicellular structure 110, an acoustic component 150, a lower multicellular structure 130 and a closing skin 103.

The upper acoustic skin 101 has the function of allowing the sound waves to be attenuated to pass inside the acoustic attenuation structure 100. For this purpose and in the example described here, the acoustic skin 110 comprises a plurality of perforations 101a.

The closing skin 103 corresponds to a solid surface intended to reflect the sound waves entering the acoustic attenuation structure. The closing skin can be a constituent element of the acoustic attenuation structure as in the example described here or correspond to a structure of an object, for example an aircraft engine. In the latter case, the acoustic attenuation structure of the invention does not include a closing skin and is directly mounted on the structure of the object.

The upper acoustic skin 101 and the closing skin 103 can be made of composite material, for example based on carbon fibers impregnated with thermoplastic or thermosetting resin. They may not comprise fibers.

The upper multicellular structure 110 comprises a plurality of partitions 111 which form a network of ribs, thus delimiting cells 112. The upper edges 111a of the partitions 111 define a first assembly face 110a of the upper multicellular structure 110. The lower edges 111b of the partitions 111 define a second assembly face 110b of the upper multicellular structure 110. Thus, the cells 112 extend from the first assembly face 110a to the second assembly face 110b of the upper multicellular structure 110.

The lower multicellular structure 130 comprises a plurality of partitions 131 which form a network of ribs, thus delimiting cells 132. The upper edges 131a of the partitions 131 define a first assembly face 130a of the lower multicellular structure 130. The lower edges 131b of the partitions 131 define a second assembly face 130b of the lower multicellular structure 130. Thus, the cells 132 extend from the first assembly face 130a to the second assembly face 130b of the lower multicellular structure 130.

The heights H₁₁₀ and H₁₃₀ of the cells 112 and 132 are chosen so as to obtain the processing of interesting frequencies according to the use of the acoustic attenuation structure.

In the example presented in FIGS. 1 and 2, the cells 112 and 132 of the upper and lower multicellular structures 110 and 130 have a hexagonal section, thus forming a structure called “honeycomb” structure. Of course, there is no departure from the framework of the invention if the upper and/or lower multicellular structures have a square, rectangular or round section of the like.

The upper and lower multicellular structures 110 and 130 can be made of polymer, composite or metal material, by additive manufacturing or according to the conventional means.

The acoustic component 150 comprises a plurality of complex hollow acoustic elements 151 each having a shape gradually tapering between a base 151a and a top 151b. The hollow acoustic elements 151 are connected to each other by one or several adjacent edges 152. The edges 152 comprise an upper face 152a, located on the same plane as the bases 151a of the hollow acoustic elements 151, and a lower face 152b opposite to the upper face 152a. The bases 151a of the hollow acoustic elements 151 and the upper face 152a of the edges 152 define an assembly face 150a of the acoustic component 150.

In the example presented in FIGS. 1 and 2, the hollow acoustic elements 151 have a pyramidal shape. However, there is no departure from the framework of the invention if the hollow acoustic elements have for example a conical, spiral or funnel shape. In the example presented in FIGS. 1 and 2, the hollow acoustic elements 151 have a symmetry of revolution. However, there is no departure from the framework of the invention if the hollow acoustic elements are asymmetrical.

Preferably, the hollow acoustic elements 151 have a thickness of less than 1 mm, for example comprised between 0.3 mm and 0.5 mm. Preferably, the base 151a of the hollow acoustic elements 151 is included in a circle whose diameter is comprised between 5 mm and 50 mm. For example, the base 151a of the hollow acoustic elements 151 is included in a circle of 20 mm in diameter.

Preferably, the height H₁₅₀ of the hollow acoustic elements 151 is comprised between 5 mm and 100 mm. For example, the height H₁₅₀ of the hollow acoustic elements 151 is 20 mm.

The acoustic component 150 can further comprise a plurality of protrusions 153, called centering pins, located on the assembly face 150a of the acoustic component 150, on the upper face 152a of the edges 152 of the hollow acoustic elements 151. The height of the protrusions 153 can be less than or equal to 2 mm.

The acoustic component 150 can be manufactured in a well-known manner by polymer, composite or metal additive manufacturing.

The acoustic component 150 can also be made in a well-known manner of thermoplastic material by injection or stamping. The thermoplastic material can be filled with short fibers or with continuous fibers. Thermoplastic material may not be filled.

The acoustic component 150 can also be made in a well-known manner by injection-compression of a filled or unfilled thermoplastic material. The injection-compression consists in injecting the material into a half-open mold. Thus, even if the material freezes, the channels are less obstructed. When the material is distributed throughout the mold, it is completely closed by a closing effort to return to the correct dimension. This makes it possible to obtain thinner wall thicknesses for the acoustic components than with a traditional injection method.

The acoustic component 150 can also be made in a well-known manner by injection with control of the temperature of the tooling of a filled or unfilled thermoplastic material. The injection with control of the temperature of the tooling consists in monitoring the temperature of the tooling or of the mold by means of a system for servo-controlling the temperature of the tooling, for example with a heat transfer fluid or with air.

The thermoplastic materials that can be used to manufacture the acoustic component 150 are in particular polyaryletherketones (PAEK) such as polyetheretherketone (PEEK) and polyetherketoneketone (PEKK), polyetherimides (PEI), polyphenylene sulfide (PPS) and polysulfone (PSU).

The acoustic attenuation structure 100 is made by fixing the upper acoustic skin 101, for example through welding or bonding, on the first assembly face 110a of the upper multicellular structure 110. The closing skin 103 is fixed, for example through welding or bonding, on the second assembly face 130b of the lower multicellular structure 130.

According to one particular embodiment of the invention, the closing skin 103 and the lower multicellular structure 130 can be formed in a single piece.

The acoustic component 150 is assembled with the lower multicellular structure 130, the upper edges 131a of the partitions 151 being fixed, for example through welding or bonding, on the lower face 152b of the edges 152 of the hollow acoustic elements 151. In the example presented in FIGS. 1 and 2, the axis of symmetry of the hollow acoustic elements 151 is coincident with the axis of symmetry of the cells 132 of the lower multicellular structure 130. Of course, there is no departure from the framework of the invention if the hollow acoustic elements 151 are offset relative to the cells 132.

According to one particular embodiment of the invention, the acoustic component 150 and the lower multicellular structure 130 can be formed in a single piece.

According to another particular embodiment of the invention, the acoustic component 150 and the upper multicellular structure 110 can be formed in a single piece. For example, in the case where the upper multicellular structure 110 has a height H₁₁₀ less than 25 mm, it is particularly desirable to make the acoustic component 150 and the upper multicellular structure 110 during the same stamping or injection operation.

The lower multicellular structure 130, the acoustic component 150 and the upper multicellular structure 110 are assembled by fixing, through bonding or welding, the second assembly face 110b of the upper multicellular structure 110 on the assembly face 150a of the acoustic component 150.

If the acoustic component 150 comprises centering pins 153, as illustrated in FIGS. 1 and 2, the centering pins 153 can be inserted into orifices present on the lower edges 111b of the partitions 111 of the upper multicellular structure 110. These orifices present on the lower edges 111b are preferably located at the intersections of several partitions 111.

The centering pins can also have grooves corresponding to the lower edges 111b of the partitions 111 of the upper multicellular structure 110, and preferably corresponding to an intersection of several partitions 111. In this configuration, it is therefore not necessary to make orifices in the lower edges of the partitions of the upper multicellular structure.

Finally, the centering pins can be placed at several angles formed between two partitions of the upper multicellular structure, the centering pins being placed at several angles of different orientations belonging to different cells of the upper multicellular structure, so as to ensure unique positioning between the acoustic component and the multicellular structure. In this configuration, it is also not necessary to make orifices in the lower edges of the partitions of the upper multicellular structure.

Thus, the centering pins 153 facilitate the positioning of the upper multicellular structure 110 on the acoustic component 150.

According to one particular embodiment of the invention, the upper multicellular structure 110, the lower multicellular structure 130 and the hollow acoustic elements 151 can be simultaneously made in a single piece, for example by additive manufacturing. The presence of the edges 152 is then not necessary.

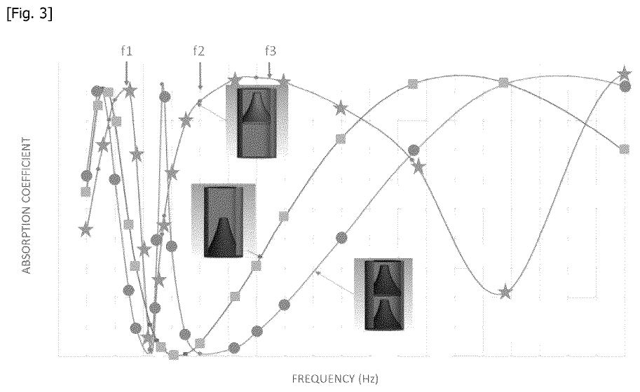

FIG. 3 presents the frequencies processed by the acoustic attenuation structure 100 according to the invention described previously, in comparison with two other acoustic attenuation structures. For example, in the case of an engine fan, it is sought to process the low frequencies f₁, as well as the harmonics f₂ and f₃. It can be seen that the acoustic attenuation structure 100 according to the invention, represented by the curve with the stars, has a high absorption coefficient for the frequencies f₁, f₂ and f₃ to be attenuated.

On the contrary, the acoustic attenuation structure whose base of the hollow acoustic element is located at the end of the acoustic attenuation structure and not at an intermediate height, represented by the curve with the squares, has a lower absorption coefficient for each of the frequencies to be processed. It is seen that if the dimensions of the acoustic structure represented by the curve with the squares were adjusted to make the peak in the low frequencies coincide with the frequency f₁, the absorption coefficient of the frequency f₂ would be extremely low.

Likewise, the acoustic attenuation structure comprising two hollow acoustic elements superimposed on each other, represented by the curve with the circles, has a lower absorption coefficient for each of the frequencies to be processed. It is seen that if the dimensions of the acoustic structure represented by the curve with the circles were adjusted to make the peak in the low frequencies coincide with f₁ and the peak in the medium frequencies coincide with f₂, the absorption coefficient of the frequency f₃ would be extremely low.

In the example presented in FIG. 2, the axes of symmetry of the cells 112 and 132 of the upper and lower multicellular structures 110 and 130 are coincident. Thus, the partitions 111 of the upper multicellular structure 110 are superimposed on the partitions 131 of the lower multicellular structure 130.

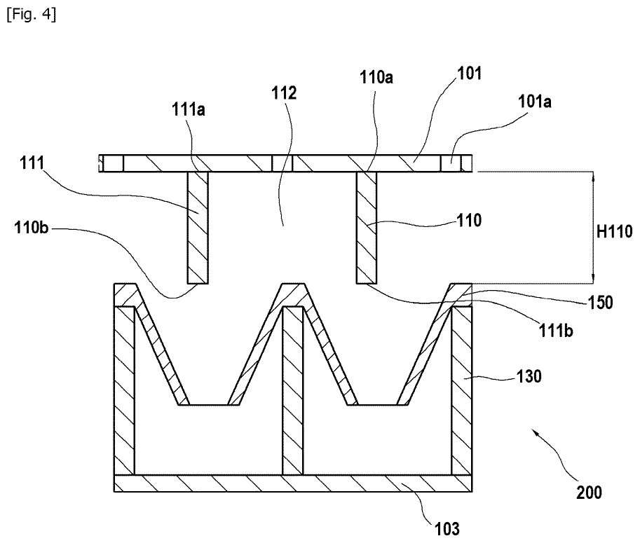

According to another embodiment of the invention illustrated by the acoustic attenuation structure 200 presented in FIG. 4, the axes of symmetry of the cells 112 and 132 of the upper and lower multicellular structures 110 and 130 are parallel but offset. Thus, the partitions 111 of the upper multicellular structure 110 are not superimposed on the partitions 131 of the lower multicellular structure 130. This configuration facilitates the operation of assembling the acoustic attenuation structure, because it is not necessary to check the alignment.

In the examples presented in FIGS. 1 to 4, the cells 112 and 132 of the upper and lower multicellular structures 110 and 130 all have a hexagonal section of the same area.

In the examples presented in FIGS. 1 to 4, the cells 112 of the lower multicellular structure have a height H₁₁₀ lower than the height H₁₃₀ of the cells 132 of the upper multicellular structure. Of course, there is no departure from the framework of the invention if the heights H₁₁₀ and H₁₃₀ of the cells 112 and 132 are identical, or if the cells 112 of the lower multicellular structure have a height H₁₁₀ greater than the height H₁₃₀ of the cells 132 of the upper multicellular structure.

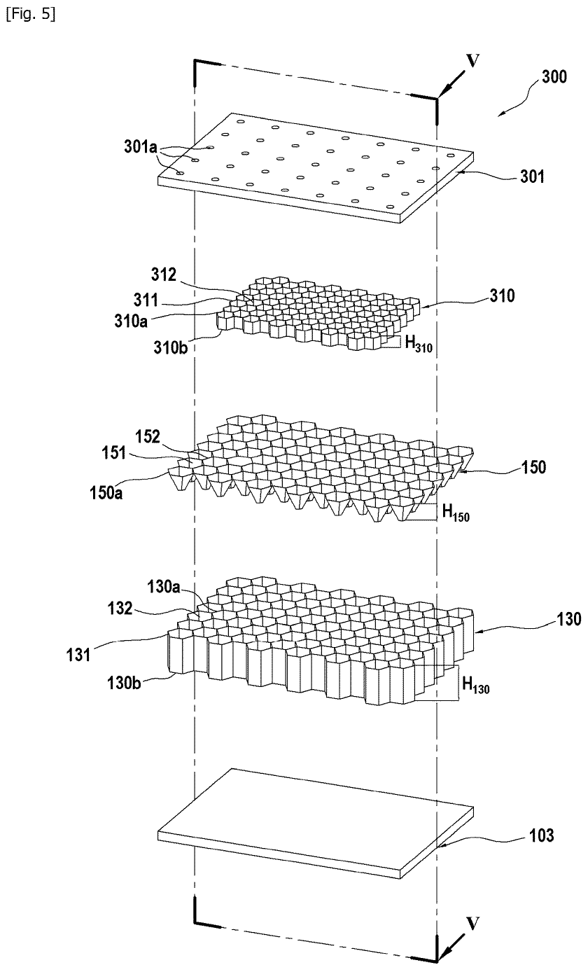

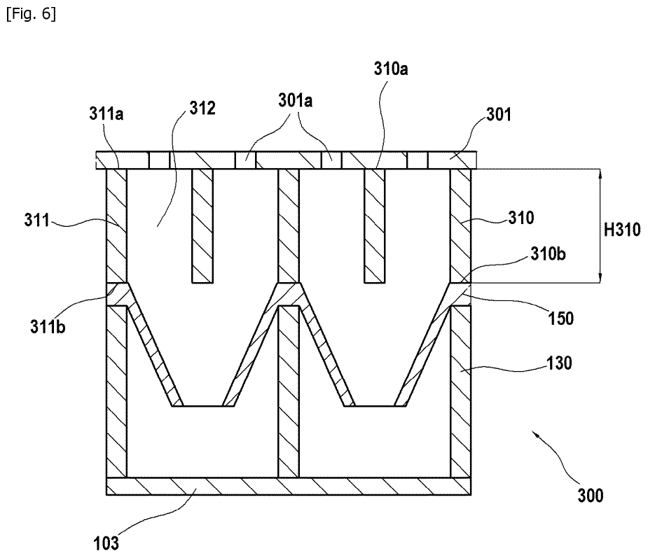

According to another embodiment of the invention illustrated in FIGS. 5 and 6, the area of the section of the cells of one of the multicellular structures can be different from the area of the section of the cells of the other multicellular structure. Thus, one of the multicellular structures can comprise a greater number of cells on a given surface than the other multicellular structure. The smaller the cells, the higher the processed frequencies.

Thus, FIGS. 5 and 6 illustrate an acoustic attenuation structure 300 comprising in order an upper acoustic skin 301, an upper multicellular structure 310, an acoustic component 150, a lower multicellular structure 130 and a closing skin 103.

In this example, the acoustic component 150, the lower multicellular structure 130 and the closing skin 103 have the same characteristics and properties as in the previous examples. Of course, there is no departure from the framework of the invention if some parameters vary, for example if the height, section, geometry, inclination and/or alignment of the elements are modified.

The upper acoustic skin 301 may have the same characteristics and properties as the upper acoustic skin 101 described previously, with the exception of the perforations 301a whose number and shape are adapted to the upper multicellular structure 310 located just below.

The upper multicellular structure 310 comprises a plurality of partitions 311 which form a network of ribs, thus delimiting cells 312. The upper edges 311a of the partitions 311 define a first assembly face 310a of the upper multicellular structure 310. The lower edges 311b of the partitions 311 define a second assembly face 310b of the upper multicellular structure 310. Thus, the cells 312 extend from the first assembly face 310a to the second assembly face 310b of the upper multicellular structure 310.

The heights H₃₁₀ and H₁₃₀ of the cells 312 and 132 are chosen so as to obtain the processing of interesting frequencies according to the use of the acoustic attenuation structure.

The area of the section of the cells 312 along a plane perpendicular to the partitions 311 is smaller than the area of the section of the cells 132 along a plane perpendicular to the partitions 131. Thus, the cells 312 of the upper multicellular structure 310 are inscribed within a circle smaller than the cells 132 of the lower multicellular structure 130.

In the example presented in FIGS. 5 and 6, the cells 312 and 132 of the upper and lower multicellular structures 310 and 130 have a hexagonal section, thus forming a structure called “honeycomb” structure. Of course, there is no departure from the framework of the invention if the upper and/or lower multicellular structures have a square, rectangular, round section or the like.

The acoustic attenuation structure 300 is made by fixing the upper acoustic skin 301, for example through welding or bonding, on the first assembly face 310a of the upper multicellular structure 310. The closing skin 103 is fixed, for example through welding or bonding, on the second assembly face 130b of the lower multicellular structure 130.

According to one particular embodiment of the invention, the closing skin 103 and the lower multicellular structure 130 can be formed in a single piece.

The acoustic component 150 is assembled with the lower multicellular structure 130, the upper edges 131a of the partitions 151 being fixed, for example through welding or bonding, on the lower face 152b of the edges 152 of the hollow acoustic elements 151.

According to one particular embodiment of the invention, the acoustic component 150 and the lower multicellular structure 130 can be formed in a single piece.

According to another particular embodiment of the invention, the acoustic component 150 and the upper multicellular structure 110 can be formed in a single piece. For example, in the case where the upper multicellular structure 110 has a height H₁₁₀ less than 25 mm, it is particularly desirable to make the acoustic component 150 and the upper multicellular structure 110 during the same stamping and injection operation.

The lower multicellular structure 130, the acoustic component 150 and the upper multicellular structure 310 are assembled by fixing, through bonding or welding, the second assembly face 310b of the upper multicellular structure 310 on the assembly face 150a of the acoustic component 150.

According to one particular embodiment of the invention, the upper multicellular structure 310, the lower multicellular structure 130 and the hollow acoustic elements 151 can be made simultaneously in a single piece, for example by additive manufacturing. The presence of the edges 152 is then not necessary.

In the examples presented in FIGS. 1 to 6, the axes of symmetry of the cells of the upper multicellular structure are directed in the same direction as the axes of symmetry of the cells of the lower multicellular structure.

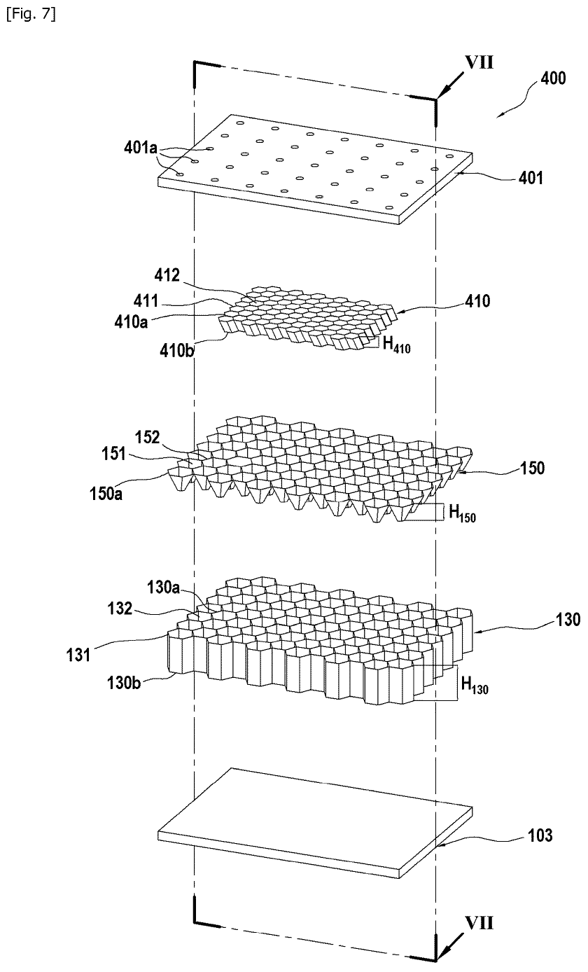

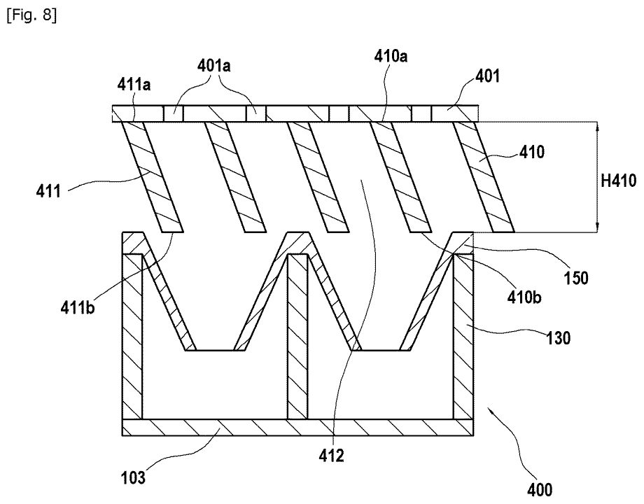

According to another embodiment presented in FIGS. 7 and 8, the cells of the upper multicellular structure can extend along a direction different from that of the cells of the lower multicellular structure. For example, in the case where the cells have symmetry of revolution, the axes of symmetry of the cells of the upper multicellular structure can be inclined relative to the axes of symmetry of the cells of the lower multicellular structure. This configuration makes it possible to process low frequencies even in the case of a limited multicellular structure thickness. Thus, at equal thickness, a multicellular structure comprising inclined cells will make it possible to process lower frequencies than a multicellular structure comprising straight cells.

Thus, FIGS. 7 and 8 illustrate an acoustic attenuation structure 400 comprising in order an upper acoustic skin 401, an upper multicellular structure 410, an acoustic component 150, a lower multicellular structure 130 and a closing skin 103.

In this example, the acoustic component 150, the lower multicellular structure 130 and the closing skin 103 have the same characteristics and properties as in the previous examples. Of course, there is no departure from the framework of the invention if some parameters vary, for example if the height, section, geometry, inclination and/or alignment of the elements are modified.

The upper acoustic skin 401 may have the same characteristics and properties as the upper acoustic skins 101 and 301 described previously.

However, the shape and number of the perforations 401a must be adapted to the upper multicellular structure 410 located just below.

The upper multicellular structure 410 comprises a plurality of partitions 411 which form a network of ribs, thus delimiting cells 412. The upper edges 411a of the partitions 411 define a first assembly face 410a of the upper multicellular structure 410. The lower edges 411b of the partitions 411 define a second assembly face 410b of the upper multicellular structure 410. Thus, the cells 412 extend from the first assembly face 410a to the second assembly face 410b of the upper multicellular structure 410.

The heights H₄₁₀ and H₁₃₀ of the cells 412 and 132 are chosen so as to obtain the processing of interesting frequencies according to the use made of the acoustic attenuation structure.

The axis of symmetry of the cells 412 of the upper multicellular structure 410 is not perpendicular to the first assembly face 410a and is not perpendicular to the second assembly face 410b of the upper multicellular structure 410. On the other hand, the axis of symmetry of the cells 132 of the lower multicellular structure 130 is perpendicular to the first assembly face 130a and to the second assembly face 130b of the lower multicellular structure 130. Thus, the angle between the axis of symmetry of the cells 412 of the upper multicellular structure 410 and the axis of symmetry of the cells 132 of the lower multicellular structure 130 is non-zero.

In the example presented in FIGS. 7 and 8, the cells 412 and 132 of the upper and lower multicellular structures 410 and 130 have a hexagonal section, thus forming a structure called “honeycomb” structure. Of course, there is no departure from the framework of the invention if the upper and/or lower multicellular structures have a square, rectangular, round section or the like.

The acoustic attenuation structure 400 is made by fixing the upper acoustic skin 401, for example through welding or bonding, on the first assembly face 410a of the upper multicellular structure 410. The closing skin 103 is fixed, for example through welding or bonding, on the second assembly face 130b of the lower multicellular structure 130.

According to one particular embodiment of the invention, the closing skin 103 and the lower multicellular structure 130 can be formed in a single piece.

The acoustic component 150 is assembled with the lower multicellular structure 130, the upper edges 131a of the partitions 151 being fixed, for example through welding or bonding, on the lower face 152b of the edges 152 of the hollow acoustic elements 151.

According to one particular embodiment of the invention, the acoustic component 150 and the lower multicellular structure 130 can be formed in a single piece.

According to another particular embodiment of the invention, the acoustic component 150 and the upper multicellular structure 110 can be formed in a single piece. For example, in the case where the upper multicellular structure 110 has a height H₁₁₀ less than 25 mm, it is particularly desirable to make the acoustic component 150 and the upper multicellular structure 110 during the same stamping and injection operation.

The lower multicellular structure 130, the acoustic component 150 and the upper multicellular structure 410 are assembled by fixing, through bonding or welding, the second assembly face 410b of the upper multicellular structure 410 on the assembly face 150a of the acoustic component 150.

According to one particular embodiment of the invention, the upper multicellular structure 410, the lower multicellular structure 130 and the hollow acoustic elements 151 can be made simultaneously in a single piece, for example by additive manufacturing. The presence of the edges 152 is then not necessary.

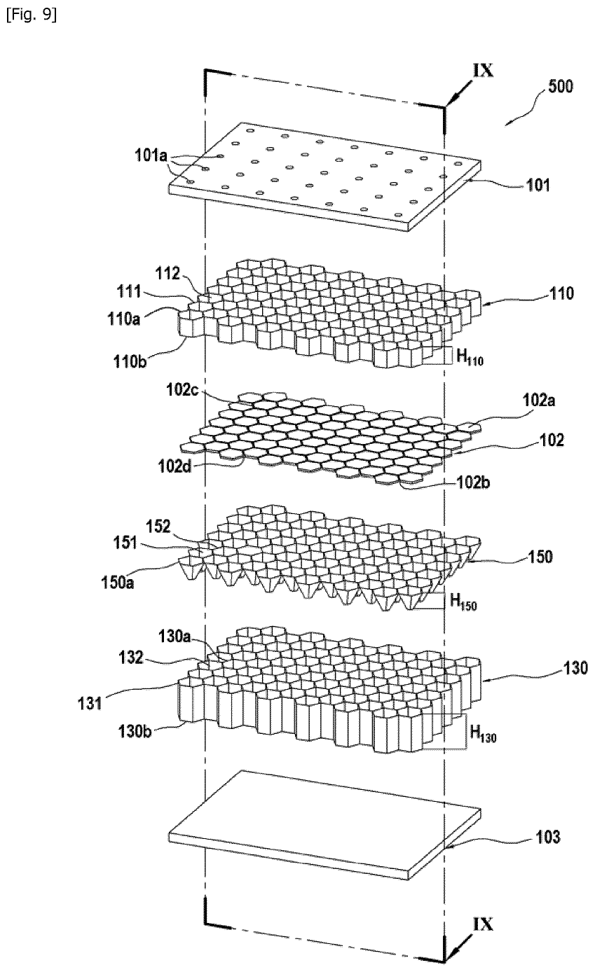

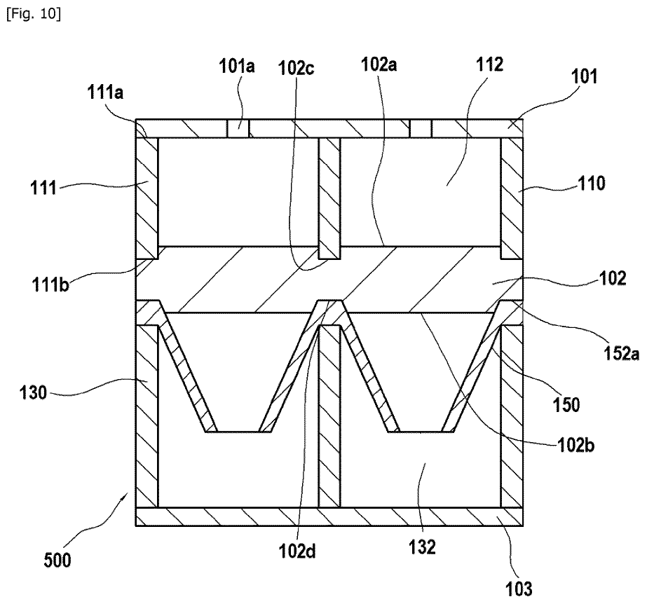

According to another embodiment presented in FIGS. 9 and 10, the acoustic attenuation structure can further comprise an intermediate acoustic skin, also called “septum”, interposed between the upper multicellular structure and the lower multicellular structure. The insertion of such an intermediate acoustic skin directly at the base of the cones makes it possible to modify the frequency absorption profile, by expanding the absorption bands.

Thus, FIGS. 9 and 10 illustrate an acoustic attenuation structure 500 comprising in order an upper acoustic skin 101, an upper multicellular structure 110, an intermediate acoustic skin 102, an acoustic component 150, a lower multicellular structure 130 and a closing skin 103.

In this example, the upper acoustic skin 101, the upper multicellular structure 110, the acoustic component 150, the lower multicellular structure 130 and the closing skin 103 have the same characteristics and properties as in the previous examples. Of course, there is no departure from the framework of the invention if some parameters vary, for example if the height, section, geometry, inclination and/or alignment of the elements are modified.

The intermediate acoustic skin 102 is an air-permeable skin. The intermediate acoustic skin 102 can take the form of a multi-perforated plate, a metal mesh or a membrane. The intermediate acoustic skin comprises a first assembly face 102a and a second assembly face 102b opposite to the first assembly face 102b.

According to one particular embodiment of the invention, the intermediate acoustic skin 102 can comprise on its first assembly face 102a the imprint 102c of the lower edges 111b of the partitions 111 of the upper multicellular structure 110, and can comprise on its second assembly face 102b of the imprint 102d of the upper faces 152a of the edges 152 and of the hollow acoustic elements 151. These imprints 102c and 102d make it possible to facilitate the centering and positioning of the intermediate acoustic skin 102 relative to the upper multicellular structure and to the acoustic component 150.

The intermediate acoustic skin 102 can be made of composite material, comprising or not comprising fibers, or made of metal material. Preferably, the intermediate acoustic skin 102 is made of thermoplastic materials such as polyaryletherketones (PAEK) such as polyetheretherketone (PEEK) and polyetherketoneketone (PEKK), polyetherimides (PEI), polycarbonate (PC), polyphenylene sulfide (PPS) and polyethersulfone (PESU), which can be filled. The intermediate acoustic skin 102 can also be made with a filled or unfilled thermosetting resin.

Depending on the material(s) chosen to make the acoustic skin 120, the acoustic skin 120 can be manufactured by machining, welding, stamping-overmolding, injection or injection-compression.

The acoustic attenuation structure 500 is made by fixing the upper acoustic skin 101, for example through welding or bonding, on the first assembly face 110a of the upper multicellular structure 110. The closing skin 103 is fixed, for example through welding or bonding, on the second assembly face 130b of the lower multicellular structure 130.

According to one particular embodiment of the invention, the closing skin 103 and the lower multicellular structure 130 can be formed in a single piece.

The acoustic component 150 is assembled with the lower multicellular structure 130, the upper edges 131a of the partitions 151 being fixed, for example through welding or bonding, on the lower face 152b of the edges 152 of the hollow acoustic elements 151.

According to one particular embodiment of the invention, the acoustic component 150 and the lower multicellular structure 130 can be formed in a single piece.

The upper multicellular structure 110 and the intermediate acoustic skin 102 are assembled by fixing, through bonding or welding, the second assembly face 110b of the upper multicellular structure 110 on the first assembly face 102a of the intermediate acoustic skin 102. The presence of an imprint 102c of the lower edges 111b of the partitions 111 of the upper multicellular structure 110 on the first assembly face 102a of the intermediate acoustic skin 102 can facilitate the positioning.

The acoustic component 150 and the intermediate acoustic skin 102 are assembled by fixing, through bonding or welding, the first assembly face 150a of the acoustic component 150 on the second assembly face 102b of the intermediate acoustic skin 102. The presence of an imprint 102d of the edges 152 and of the hollow acoustic elements 151 of the acoustic component 150 on the second assembly face 102b of the intermediate acoustic skin 102 can facilitate the positioning.

In the case where the intermediate acoustic skin 102 is made of metal material or of composite material with metal particles, the assembly of the intermediate acoustic skin 102 with the acoustic component 150 and/or the upper multicellular structure 110 can be carried out through resistive welding or induction, the intermediate acoustic skin 102 adopting the role of susceptor.

According to one particular embodiment of the invention, the acoustic component 150 and the intermediate acoustic skin 102 can be formed in a single piece.

According to another particular embodiment of the invention, the upper multicellular structure 110 and the intermediate acoustic skin 102 can be formed in a single piece.

According to one particular embodiment of the invention, the upper multicellular structure 110, the lower multicellular structure 130, the intermediate acoustic skin 102 and the hollow acoustic elements 151 can be made simultaneously in a single piece, for example by additive manufacturing. The presence of the edges 152 is then not necessary.

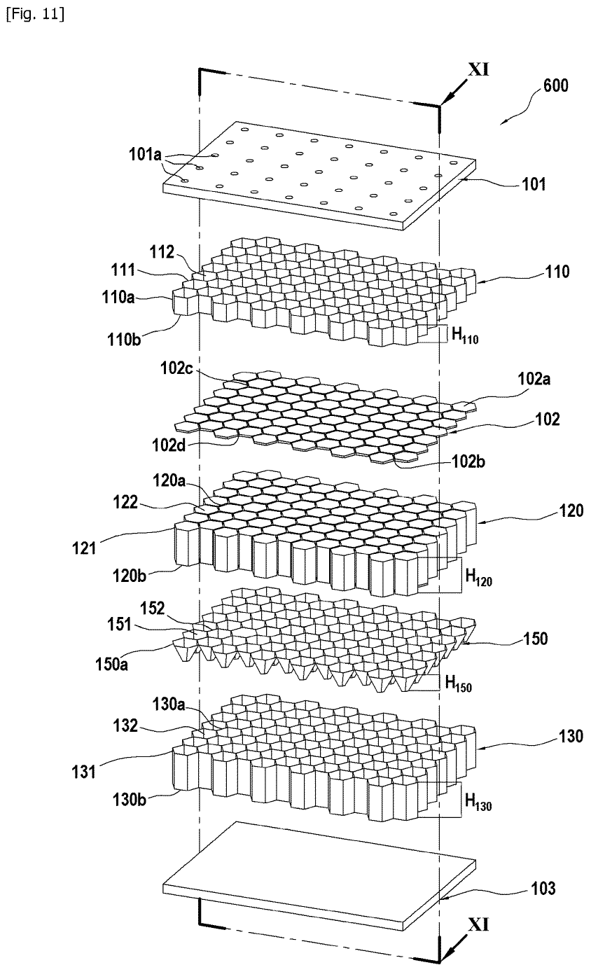

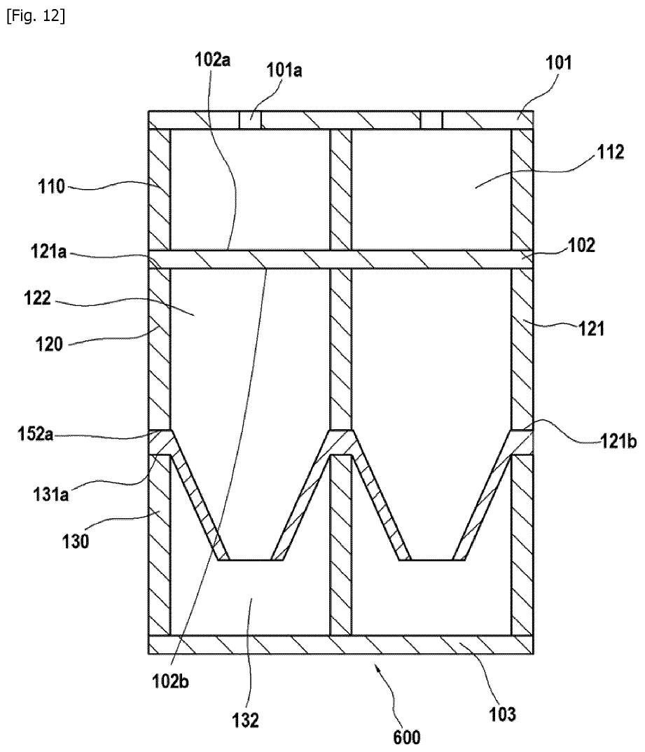

According to another embodiment presented in FIGS. 11 and 12, the acoustic attenuation structure can comprise not only an intermediate acoustic skin, also called “septum”, but also an intermediate multicellular structure.

Thus, the spectrum of processed frequencies, and more particularly the frequencies and widths of the absorption peaks can be modified according to the offset of the intermediate acoustic skin relative to the base of the cones.

Thus, FIGS. 11 and 12 illustrate an acoustic attenuation structure 600 comprising in order an upper acoustic skin 101, an upper multicellular structure 110, an intermediate acoustic skin 102, an intermediate multicellular structure 120, an acoustic component 150, a lower multicellular structure 130 and a closing skin 103.

In this example, the upper acoustic skin 101, the upper multicellular structure 110, the acoustic component 150, the lower multicellular structure 130 and the closing skin 103 have the same characteristics and properties as in the previous examples. Of course, there is no departure from the framework of the invention if some parameters vary, for example if the height, section, geometry, inclination and/or alignment of the elements are modified.

The intermediate multicellular structure 120 comprises a plurality of partitions 121 which form a network of ribs, thus delimiting cells 122. The upper edges 121a of the partitions 121 define a first assembly face 120a of the lower multicellular structure 120. The lower edges 121b of the partitions 121 define a second assembly face 120b of the lower multicellular structure 120. Thus, the cells 122 extend from the first assembly face 120a to the second assembly face 120b of the lower multicellular structure 120.

The heights H₁₁₀, H₁₂₀ and H₁₃₀ of the cells 112, 122 and 132 are chosen so as to obtain the processing of interesting frequencies according to the use of the acoustic attenuation structure.

The intermediate multicellular structure 120 can be manufactured with the materials and according to the manufacturing methods or embodiments described previously for the other multicellular structures.

In the example presented in FIGS. 11 and 12, the intermediate multicellular structure 120 is identical to the lower multicellular structure and to the upper multicellular structure. However, the intermediate multicellular structure 120 can also have cells with a geometric shape, height, section area or inclination different from that of the lower multicellular structure or of the upper multicellular structure.

The intermediate acoustic skin 102 may have the same characteristics as previously, with the exception of the possible imprint on its second assembly face. Indeed, in this example, if the intermediate acoustic skin 102 has an imprint on its second assembly face, the imprint is that of the lower edges 121b of the partitions 121 of the lower multicellular structure 120.

The acoustic attenuation structure 600 is made by fixing the upper acoustic skin 101, for example through welding or bonding, on the first assembly face 110a of the upper multicellular structure 110. The closing skin 103 is fixed, for example through welding or bonding, on the second assembly face 130b of the lower multicellular structure 130.

According to one particular embodiment of the invention, the closing skin 103 and the lower multicellular structure 130 can be formed in a single piece.

The acoustic component 150 is assembled with the lower multicellular structure 130, the upper edges 131a of the partitions 151 being fixed, for example through welding or bonding, on the lower face 152b of the edges 152 of the hollow acoustic elements 151.

According to one particular embodiment of the invention, the acoustic component 150 and the lower multicellular structure 130 can be formed in a single piece.

The upper multicellular structure 110 and the intermediate acoustic skin 102 are assembled by fixing, through bonding or welding, the second assembly face 110b of the upper multicellular structure 110 on the first assembly face 102a of the intermediate acoustic skin 102. The presence of an imprint 102c of the lower edges 111b of the partitions 111 of the upper multicellular structure 110 on the first assembly face 102a of the intermediate acoustic skin 102 can facilitate the positioning.

The intermediate multicellular structure 120 and the intermediate acoustic skin 102 are assembled by fixing, through bonding or welding, the first assembly face 120a of the multicellular structure 120 on the second assembly face 102b of the intermediate acoustic skin 102. The presence of an imprint of the lower edges 121b of the partitions 121 of the intermediate multicellular structure 120 on the second assembly face 102b of the intermediate acoustic skin 102 can facilitate the positioning.

In the case where the intermediate acoustic skin 102 is made of metal material or composite material with metal particles, the assembly of the intermediate acoustic skin 102 with the multicellular structure(s) 110 and 120 can be carried out through resistive welding or induction, the intermediate acoustic skin 102 adopting the role of a susceptor.

According to one particular embodiment of the invention, the intermediate multicellular structure 120 and the intermediate acoustic skin 102 can be formed in a single piece.

According to another particular embodiment of the invention, the upper multicellular structure 110 and the intermediate acoustic skin 102 can be formed in a single piece.

The intermediate multicellular structure 120 and the acoustic component 150 are assembled by fixing, through bonding or welding, the second assembly face 120b of the intermediate multicellular structure 120 on the assembly face 150a of the acoustic component 150.

According to one particular embodiment of the invention, the upper multicellular structure 110, the intermediate multicellular structure 120 and the hollow acoustic elements 151 can be made simultaneously in a single piece, for example by additive manufacturing. The presence of the edges 152 is then not necessary.

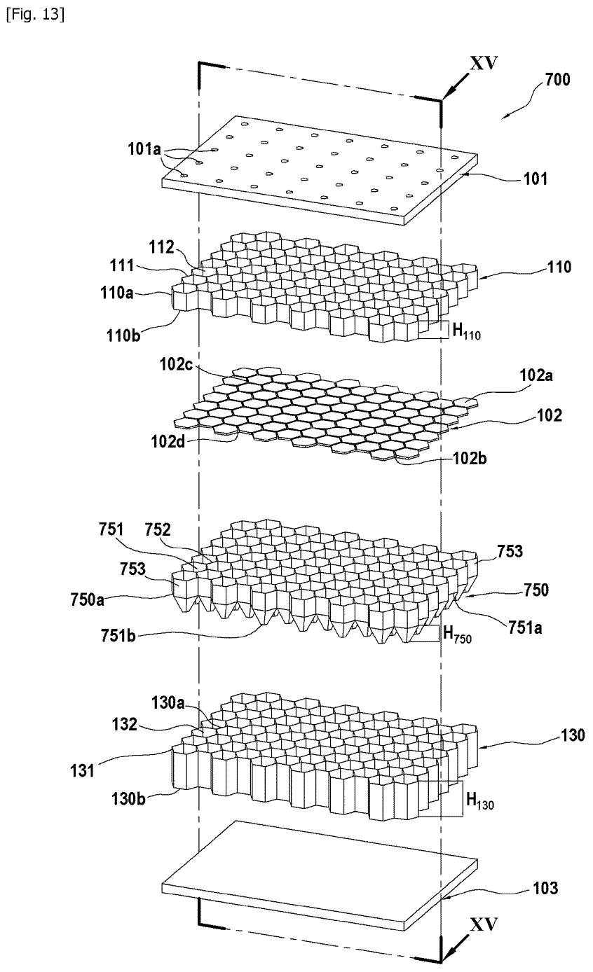

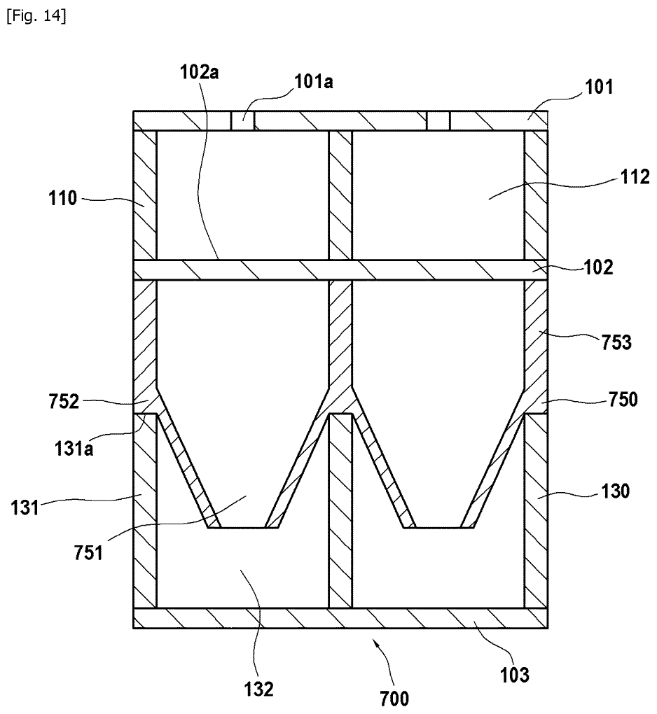

According to another embodiment of the invention illustrated in FIGS. 13 and 14, an intermediate skin can be placed at an intermediate height in the upper multicellular structure.

Thus, FIGS. 13 and 14 illustrate an acoustic attenuation structure 700 comprising an upper acoustic skin 101, an upper multicellular structure 310, an intermediate acoustic skin 102, an acoustic component 750, a lower multicellular structure 130 and a closing skin 103.

In this example, the upper acoustic skin 101, the upper multicellular structure 110, the intermediate acoustic skin 102, the lower multicellular structure 130 and the closing skin 103 have the same characteristics and properties as in the previous examples. Of course, there is no departure from the framework of the invention if some parameters vary, for example if the height, section, geometry, inclination and/or alignment of the elements are modified.

The acoustic component 750 comprises a plurality of complex hollow acoustic elements 751 each having a shape gradually tapering between a base 751a and a top 751b. The hollow acoustic elements 751 are connected to each other by one or several adjacent edges 752. The edges 752 comprise an upper face 752a, located on the same plane as the bases 751a of the hollow acoustic elements 751, and a lower face 752b opposite to the upper face 752a. The bases 751a of the hollow acoustic elements 751 and the upper face 752a of the edges 752 define an assembly face 750a of the acoustic component 750.

In the example presented in FIGS. 13 and 14, the hollow acoustic elements 751 have a pyramidal shape. However, Of course, there is no departure from the framework of the invention if the hollow acoustic elements have, for example, a conical, spiral or funnel shape. In the example presented in FIGS. 13 and 14, the hollow acoustic elements 751 have symmetry of revolution. However, there is no departure from framework of the invention if the hollow acoustic elements are asymmetrical.

Preferably, the hollow acoustic elements 751 have a thickness of less than 1 mm, for example comprised between 0.3 mm and 0.5 mm. Preferably, the base 751a of the hollow acoustic elements 751 is included in a circle whose diameter is comprised between 5 mm and 50 mm. For example, the base 751 a of the hollow acoustic elements 751 is included in a circle of 20 mm in diameter.

Preferably, the height H₇₅₀ of the hollow acoustic elements 751 is comprised between 5 mm and 100 mm. For example, the height H₇₅₀ of the hollow acoustic elements 751 is 20 mm.

The acoustic component 750 further comprises extension walls 753. Each extension wall 753 extends from the base 751a of a hollow acoustic element 751, for example from the upper face 752a of the edges 752. The upper edge of each extension wall 753 is intended to be in contact with the intermediate acoustic skin 102. Thus, the extension walls 753 and the intermediate acoustic skin 102 define a plurality of cavities, which fulfill an acoustic function similar to that of an intermediate multicellular structure.

In the example illustrated in FIGS. 13 and 14, the extension walls 753 extend in the same direction as the cells of the upper multicellular structure or of the lower multicellular structure. Of course, there is no departure from the framework of the invention if the extension walls 753 are oriented differently.

The acoustic component 750 can be manufactured in a well-known manner by polymer, composite or metal additive manufacturing.

The acoustic component 750 can also be partially made in a well-known manner of thermoplastic material by injection or stamping. The thermoplastic material can be filled with short fibers or with continuous fibers. The thermoplastic material may not be filled.

The acoustic component 750 can also be partially made in a well-known manner by injection-compression of a filled or unfilled thermoplastic material or by injection with control of the temperature of the tooling of a filled or unfilled thermoplastic material.

The thermoplastic materials which can be used to manufacture at least partly the acoustic component 750 are in particular polyaryletherketones (PAEK) such as polyetheretherketone (PEEK) and polyetherketoneketone (PEKK), polyetherimides (PEI), polyphenylene sulfide (PPS) and polysulfone (PSU).

In the example presented in FIGS. 13 and 14, the cells 112 and 132 of the upper and lower multicellular structures 110 and 130 have a hexagonal section, thus forming a structure called “honeycomb” structure. Of course, there is no departure from the framework of the invention if the upper and/or lower multicellular structures have a square, rectangular, round section or the like The acoustic attenuation structure 700 is made by fixing the upper acoustic skin 101, for example through welding or bonding, on the first assembly face 110a of the upper multicellular structure 110. The closing skin 103 is fixed, for example through welding or bonding, on the second assembly face 130b of the lower multicellular structure 130.

According to one particular embodiment of the invention, the closing skin 103 and the lower multicellular structure 130 can be formed in a single piece.

The acoustic component 750 is assembled with the lower multicellular structure 130, the upper edges 131a of the partitions 751 being fixed, for example through welding or bonding, on the lower face 752b of the edges 752 of the hollow acoustic elements 751.

The upper multicellular structure 110 and the intermediate acoustic skin 102 are assembled by fixing, through bonding or welding, the second assembly face 110b of the upper multicellular structure 110 on the first assembly face 102a of the intermediate acoustic skin 102. The presence of an imprint 102c of the lower edges 111b of the partitions 111 of the upper multicellular structure 110 on the first assembly face 102a of the intermediate acoustic skin 102 can facilitate the positioning.

The acoustic component 750 and the intermediate acoustic skin 102 are assembled by fixing, through bonding or welding, the first assembly face 750a of the acoustic component 750 on the second assembly face 102b of the intermediate acoustic skin 102. The presence of an imprint 102d of the upper edges of the extension walls 753 of the acoustic component 750 on the second assembly face 102b of the intermediate acoustic skin 102 can facilitate the positioning.

In the case where the intermediate acoustic skin 102 is made of metal material or of composite material with metal particles, the assembly of the intermediate acoustic skin 102 with the acoustic component 750 and/or the upper multicellular structure 110 can be carried out through resistive welding or induction, the intermediate acoustic skin 102 adopting the role of a susceptor.

According to one particular embodiment of the invention, the acoustic component 750 and the intermediate acoustic skin 102 can be formed in a single piece.

According to one particular embodiment of the invention, the upper multicellular structure 110, the intermediate acoustic skin 102, the lower multicellular structure 130, the hollow acoustic elements 751 and the extension walls 753 can be made simultaneously in a single piece, by for example by additive manufacturing.

The embodiments presented above and in FIGS. 1 to 14 can be combined. For example, there is no departure from the framework of the invention if the height, section, geometry, size or inclination of the cells of one or several multicellular structures is modified in the examples given for the different embodiments of the invention.

1. An acoustic attenuation structure comprising a lower multicellular structure and an upper multicellular structure, at least part of the cells of the upper multicellular structure opening out at least partially into one or several cells of the lower multicellular structure, the acoustic attenuation structure wherein a hollow acoustic element having a shape gradually tapering between a base and a top is present in each cell of at least part of the lower multicellular structure

2. The acoustic attenuation structure according to claim 1, wherein the base of the hollow acoustic element is present at the end of the cell of the lower multicellular structure located facing the upper multicellular structure.

3. The acoustic attenuation structure according to claim 1, wherein an intermediate acoustic skin is present at the end of the cells of the upper multicellular structure located facing the cells of the lower multicellular structure having hollow acoustic elements.

4. The acoustic attenuation structure according to claim 3, wherein the intermediate acoustic skin is in contact with the base of the hollow acoustic elements present in the cells of the lower multicellular structure.

5. The acoustic attenuation structure according to claim 3, wherein each hollow acoustic element comprises extension walls extending from the base of said acoustic element to the intermediate acoustic skin.

6. The acoustic attenuation structure according to claim 1, further comprising an intermediate multicellular structure so that at least part of the cells of the intermediate multicellular structure opens out at least partially into one or several cells of the lower multicellular structure and at least partially into one or several cells of the upper multicellular structure.

7. The acoustic attenuation structure according to claim 1, wherein the cells of the lower multicellular structure have a geometric shape identical to the geometric shape of the cells of the upper multicellular structure.

8. The acoustic attenuation structure according to claim 1, wherein the cells of the lower multicellular structure have an area section different from the area of the section of the cells of the upper multicellular structure.

9. The acoustic attenuation structure according to claim 1, wherein the height of the cells of the lower multicellular structure is different from the height of the cells of the upper multicellular structure.

10. The acoustic attenuation structure according to claim 1, wherein the cells of the lower multicellular structure extend along a first direction and the cells of the upper multicellular structure extend along a second direction, the first direction and the second direction being secant.
